(19) United States
(12) Patent Application Publication
(10) Pub. No.: US 2009/0234959 A1
(43) Pub. Date: Sep. 17, 2009

(54) PROXYING MULTIPLE INITIATORS AS A VIRTUAL INITIATOR USING IDENTIFIER RANGES

(75) Inventor: Lintu THOMAS, San Jose, CA (US)

Correspondence Address: CONLEY ROSE, P.C.;David A. Rose, P. O. BOX 3267, HOUSTON, TX, 77253-3267, US

(73) Assignee: BROCADE COMMUNICATIONS SYSTEMS, INC., San Jose, CA (US)

(21) Appl. No.: 12/049,621

(22) Filed: Mar. 17, 2008

(51) Int. Cl. G06F 15/16

(52) U.S. Cl. 709/230

(57) ABSTRACT

A gateway includes a Fibre Channel (“FC”) port configured to couple to a FC target, and an internet small computer system interface (“iSCSI”) port configured to couple to iSCSI initiators. The iSCSI port is configured to facilitate communication between the iSCSI initiators and the FC target, and proxy the iSCSI initiators as a single virtual FC initiator. The iSCSI port is also configured to divide the FC Origination Exchange Identifier (“OX_ID”) range into a plurality of subdivided communication identifier ranges, and associate the iSCSI initiators with the subdivided communication ranges.

### BACKGROUND

Computer networking has become the focus of much attention in the data communications industry. Performance improvements in processors and peripherals, along with the move to distributed architectures such as client-server configurations, have spawned increasingly data-intensive networking applications. Various protocols have been developed to provide the necessary communications capacity corresponding to such applications. Hence, there exists a need for intercommunication between computer networks that use different protocols. For example, many customers would prefer to expand their existing networks with the latest protocol. Other customers simply need low-latency communication between dissimilar protocols. Integrating protocols is therefore highly desirable.

### SUMMARY

Devices, systems, and methods for proxying multiple initiators as a virtual initiator are described herein. A gateway includes a Fibre Channel (“FC”) port configured to couple to a FC target, and an internet small computer system interface (“iSCSI”) port configured to couple to iSCSI initiators. The iSCSI port is configured to facilitate communication between the iSCSI initiators and the FC target, and proxy the iSCSI initiators as a single virtual FC initiator. The iSCSI port is also configured to divide the FC Origination Exchange Identifier (“OX_ID”) range into a plurality of subdivided communication identifier ranges, and associate the iSCSI initiators with the subdivided communication ranges.

A computer network includes a FC network and an iSCSI network. The FC network includes a FC target and the iSCSI network includes iSCSI initiators. The computer network also includes a gateway coupled to the FC network and the iSCSI network. The gateway includes a FC port configured to couple to the FC target, and an iSCSI port configured to couple to the iSCSI initiators. The iSCSI port is configured to facilitate communication between the iSCSI initiators and the FC target, and proxy the iSCSI initiators as a single virtual FC initiator. The iSCSI port is also configured to divide the FC OX_ID range into a plurality of subdivided communication identifier ranges, and associate the iSCSI initiators with the subdivided communication ranges.

A method includes receiving a packet from an iSCSI initiator at a virtual iSCSI target, inserting an OX_ID associated with the iSCSI initiator into the packet; and sending the packet to a FC target from a virtual FC initiator.

A computer-readable medium stores a software program that, when executed by a processor, causes the processor to receive a packet from an iSCSI initiator at a virtual iSCSI target, insert an OX_ID associated with the iSCSI initiator into the packet, and send the packet to a FC target from a virtual FC initiator.

A method includes receiving a Fibre Channel frame from a Fibre Channel target at a virtual Fibre Channel initiator, reading the OX_ID located in the Fibre Channel frame, identifying an iSCSI initiator out of multiple iSCSI initiators via the Origination Exchange Identifier, converting the Fibre Channel frame to an iSCSI packet, and sending the iSCSI packet to the iSCSI initiator via a virtual iSCSI target.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the accompanying drawings and detailed description, wherein like reference numerals represent like parts:

FIG. 1 illustrates a computer network in accordance with at least some illustrative embodiments;

FIG. 1B illustrates an iSCSI port in accordance with at least some illustrative embodiments;

FIG. 2 illustrates a method for proxying multiple initiators in accordance with at least some illustrative embodiments;

FIG. 3 illustrates a method for proxying multiple initiators in accordance with at least some illustrative embodiments;

FIG. 4 illustrates a general-purpose computer suitable for implementing one or more embodiments described herein; and

FIG. 5 is a block diagram of a gateway according to the preferred embodiment.

### NOTATION AND NOMENCLATURE

Certain terms are used throughout the following claims and discussion to refer to particular components. This document does not intend to distinguish between components that differ in name but not function. In the following discussion and in the claims, the terms “including” and “comprising” are used in an open-ended fashion, and thus should be interpreted to mean “including but not limited to.” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more hardware components.

The term “initiator” is used to refer to a network element that initiates communication, and, as used in this document, is not associated with a particular protocol, e.g. iSCSI, but with all protocols. The term “target” is used to refer to a network element that responds to the initiator, and, as used in this document, is not associated with a particular protocol, e.g. iSCSI, but with all protocols.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

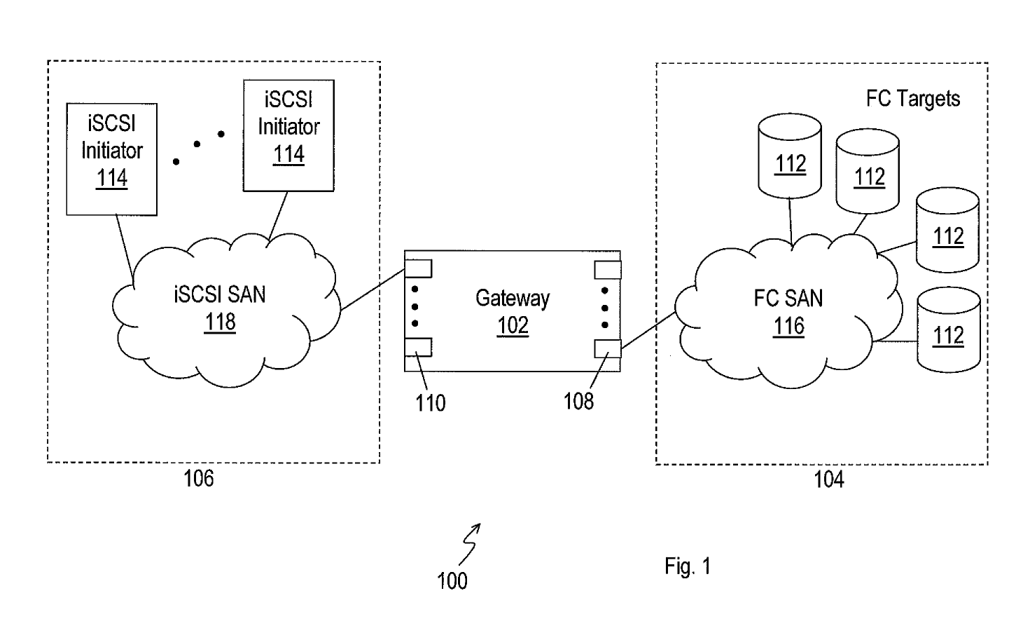

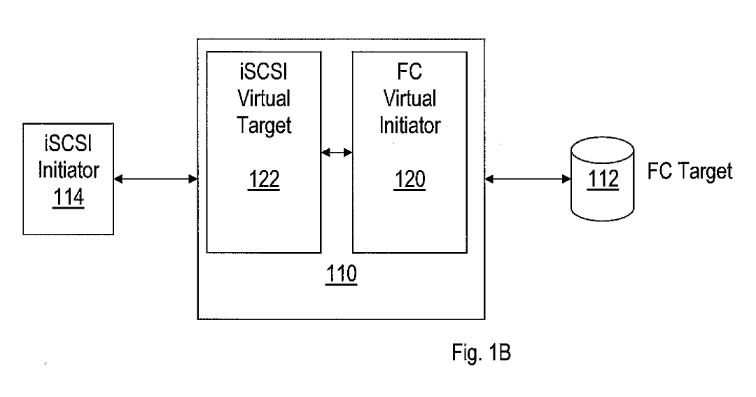

FIG. 1 illustrates a system 100 including a gateway 102 coupled to a Fibre Channel (“FC”) network 104 and an Internet Small Computer System Interface (“iSCSI”) network 106 through at least one FC port 108 and at least one iSCSI port 110, respectively. A discussion of FC and iSCSI protocol will be helpful.

Fibre Channel protocol can carry data at rates exceeding 2 Gbps in both directions simultaneously, and defines standard media and signaling conventions for transporting data in a serial fashion. FC also provides a frame structure for transporting the data; the frame structure is termed a “Fibre Channel frame” or simply a “frame.”

In FC, the “Originator Exchange Identifier,” or “OX_ID,” is a 16-bit field in the frame that uniquely identifies the “originator” of a communication session. The communication session is also termed an “exchange”. An originator initiates exchanges while a “responder” replies to exchanges that the responder receives. An OX_ID value of 0xFFFF indicates that the OX_ID is unassigned. Similarly, the “responder exchange identifier,” or “RX_ID,” is a 16-bit field in the frame that uniquely identifies the responder of an exchange, and a RX_ID value of 0xFFFF indicates that the RX_ID is unassigned. In the first frame of an exchange, the originator assigns the OX_ID by setting the OX_ID value to a value other than 0xFFFF. The originator sets the RX_ID value to 0xFFFF, the unassigned value. Upon receipt of the first frame, the responder assigns the RX_ID by setting the RX_ID value to a value other than 0xFFFF. The assigned values for the OX_ID and RX_ID are used for all subsequent frames in the exchange.

The iSCSI protocol allows the use of the SCSI protocol over Transmission Control Protocol/Internet Protocol (“TCP/IP”) networks. SCSI is a set of standards for physically connecting and transferring data between computers and peripheral devices such as hard disks, tape drives, scanners, and optical drives. SCSI is a client-server architecture. Clients of a SCSI interface are termed “initiators.” Initiators issue SCSI “commands” to request services from components, also known as logical units, of a server. The servers are known as “targets.” The initiator is one endpoint of a SCSI transport. The target is the other endpoint. As used in this document, however, the terms “initiator” and “target” are not indicative that SCSI or iSCSI protocol is in use.

SCSI commands are sent in a Command Descriptor Block (“CDB”). The CDB includes a one byte operation code followed by five or more bytes containing command-specific parameters. A target can contain multiple logical units. Each logical unit has an address within a target termed a logical unit number (“LUN”), the value of which is used to identify the logical unit during a communication session. The LUN field is 64 bits.

Returning to FIG. 1, the gateway 102 is coupled to iSCSI initiators 114 and FC targets 112. Such coupling may be through iSCSI storage area networks (“SANs”) 118 and FC SANs 116, respectively. A SAN is any arrangement of interconnected network elements that transport packets of information between any attached devices. Network elements include routers, switches, initiators, targets, etc. Preferably, the iSCSI initiators 114 are computer servers, while the FC targets 112 are FC storage units, and each iSCSI port 110 supports 64 iSCSI initiators 114. Thus, if the gateway 102 includes 8 iSCSI ports, the gateway supports 512 iSCSI initiators. The use of protocols other than iSCSI and FC will become apparent to those skilled in the art, and using such protocols is within the scope of the present disclosure.

FIG. 1B illustrates an iSCSI port 110, which couples the iSCSI initiator 114 to the FC target 112 (the gateway 102 and FC port 108 are not pictured). The port 110 includes a virtual iSCSI target 122 and a virtual FC initiator 120. A virtual iSCSI target 122 is an emulation of an iSCSI target in software. Similarly, a virtual FC initiator is an emulation of a FC originator in software. Also, the port 110 is preferably converts iSCSI packets into Fibre Channel frames and vice versa. As such, the iSCSI initiator 114, from its own point of view, appears to be initiating communication with an iSCSI target, while the FC target 112, from its own point of view, appears to be responding to communication from a FC initiator. Objectively, the iSCSI port 110 is facilitating communication between the iSCSI initiator 114 and the FC target 112.

In order for multiple iSCSI initiators 114 to communicate with one FC target 112 through the iSCSI port 110, each iSCSI target should be uniquely identified in such a way as to withstand packet conversion. As such, the iSCSI port 110 proxies multiple iSCSI initiators 114 as the virtual FC initiator 120 by dividing a communication identifier range associated with the FC protocol, the OX_ID, into multiple subdivided communication identifier ranges, or subdivided OX_ID ranges.

The iSCSI port 110 preferably also associates each of the iSCSI initiators 114 with one of the subdivided OX_ID ranges. By associating each iSCSI initiator 114 with a subdivided OX_ID range, each iSCSI initiator 114 may use multiple OX_IDs as long as the OX_IDs are within the subdivided OX_ID range. As such, the iSCSI port 110 is configured to read an OX_ID in a packet and determine which iSCSI initiator 114 the packet should be sent to, by determining the subdivided OX_ID range to which the OX_ID belongs and the iSCSI initiator 114 which is associated with that subdivided OX_ID range. If the OX_ID is unassigned, the port 110 preferably inserts an OX_ID from the range of OX_IDs associated with the iSCSI initiator 114. Subsequent communication between the iSCSI initiator 114 and FC target 112 can be identified and redirected based on the OX_ID.

For example, the assignable OX_ID range {0x0000-0xFFFE} is divided into 64 subdivided ranges {0x0000-0x03FF, 0x0400-0x07FF, . . . . } such that the port 110 can support communication sessions between 64 iSCSI initiators 114 and the FC target 112 simultaneously. Communication identified with an OX_ID value of 0x0001 and 0x000A would be directed to one iSCSI initiator because the values belong to the first subdivided OX_ID range. Communication identified with an OX_ID value of 0x0400 would be directed to another iSCSI initiator because the value belongs to another subdivided OX_ID range. Preferably, the iSCSI port 110 creates and stores a data structure with the subdivided range associations, and accesses the data structure to determine such associations.

Preferably, the subdivided communication identifier ranges do not overlap with each other, and each subdivided communication identifier range is continuous. Such restrictions, while not mandatory, reduce the complexity of the data structure associating the subdivided communication identifier ranges with the iSCSI initiators 114. Also, the entire set of assignable identifiers need not be subdivided; rather, only a portion of the entire set may be subdivided. Preferably, a range of 4096 identifiers is used (e.g., the identifiers between 0x0000 and 0x0FFF divided among 64 iSCSI initiators).

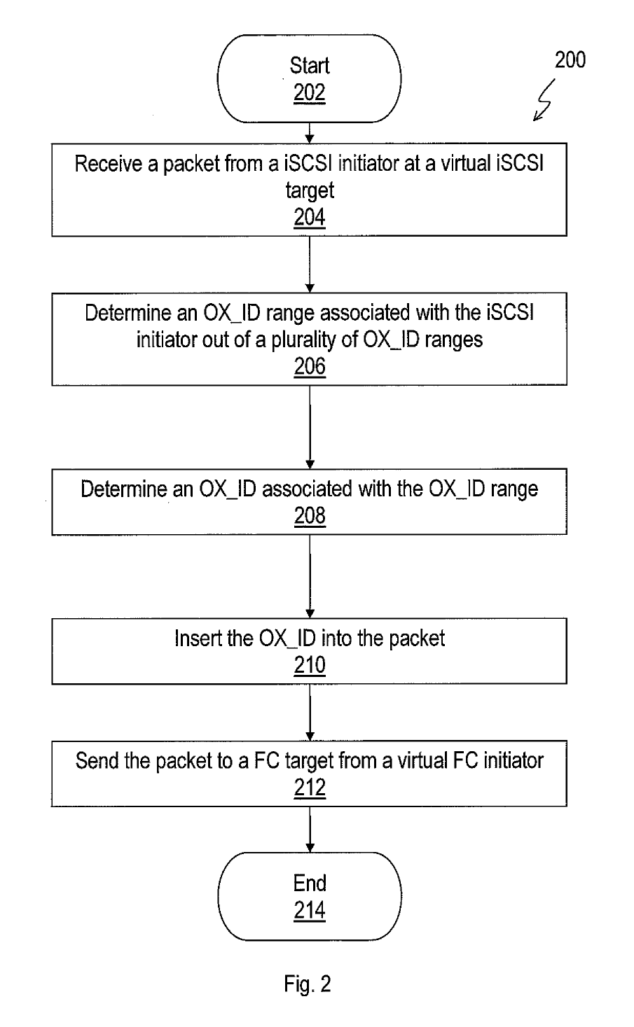

FIG. 2 illustrates a method 200 of proxying multiple iSCSI initiators as a virtual FC initiator, beginning at 202 and ending at 214. At 204, an iSCSI packet is received at a virtual iSCSI target from an iSCSI initiator. Preferably, the range of possible communication identifiers, 0x0000-0xFFFE, has previously been divided into subdivided ranges of communication identifiers. Also, a table associating each communication identifier with a subdivided range of communication identifiers, and each subdivided range of communication identifiers with one of the iSCSI initiators, preferably has previously been constructed. The table is updated as initiators and targets are added and removed from their respective networks.

At 206, the subdivided OX_ID range associated with the iSCSI initiator is determined, preferably by reading the appropriate entry in the table. At 208, an OX_ID associated with the subdivided OX_ID range is determined, preferably by reading the table as well. Preferably, the OX_ID is an element of the subdivided OX_ID range associated with the iSCSI initiator. In various embodiments, these elements of the method may be combined. Also, the table may directly associate the OX_ID with the iSCSI initiator rather than using the subdivided OX_ID range, hence simplifying the determination of the iSCSI initiator.

Preferably, the iSCSI packet is converted into a FC frame, and at 210, the OX_ID associated with the iSCSI initiator is inserted into the frame. In an alternative embodiment, the iSCSI initiator inserts the communication identifier into the iSCSI packet prior to sending the packet. Depending on which types of protocols are used, a protocol conversion may involve encapsulation and decapsulation of packets, including stripping and adding protocol headers. For example, to convert a FC frame into an iSCSI packet, the cyclic redundancy check value (“CRC”) is deleted from the frame, and an Ethernet header is added. To convert an iSCSI packet into a FC frame, a CRC is appended to the payload of the packet. At 212, the frame is sent to the FC target from a virtual FC initiator.

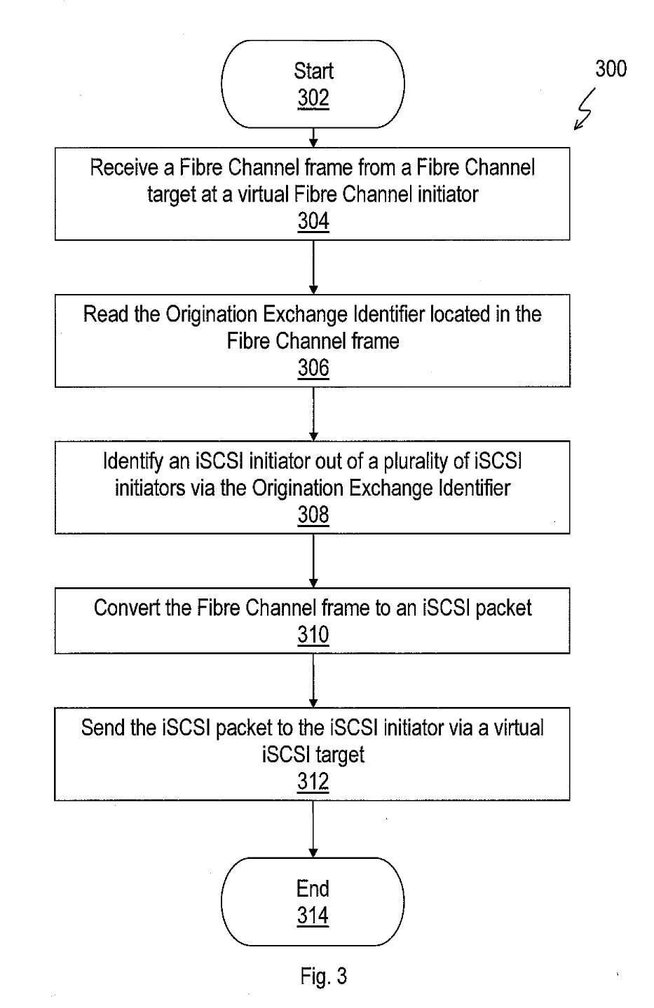

FIG. 3 illustrates a method 300 of proxying multiple iSCSI initiators as a virtual FC initiator, beginning at 302 and ending at 314. At 304, a FC frame is received at a virtual FC initiator. Preferably, the range of possible OX_IDs, 0x0000-0xFFFE, has previously been divided into subdivided ranges of OX_IDs. Also, a table associating each OX_ID with a subdivided range of OX_IDs, and each subdivided range of OX_IDs with an iSCSI initiator, preferably has previously been constructed. Preferably, the table is updated as initiators and targets are added and removed from the networks.

At 306, the OX_ID in the frame is read. At 308, an iSCSI initiator for which the frame is intended is identified via the OX_ID. Preferably, the subdivided OX_ID range associated with the OX_ID, and the iSCSI initiator associated with the subdivided OX_ID range, is determined by reading the appropriate entry in the table. At 310, the FC frame is converted into an iSCSI packet. As mentioned above, depending on which types of protocols are used, such a conversion may involve encapsulation and decapsulation of protocol packets, including stripping and adding protocol headers. To convert a FC frame into an iSCSI packet, the CRC is deleted and an Ethernet header is added. To convert an iSCSI packet into a FC frame, a CRC is appended to the payload of the packet. At 312, the iSCSI packet is sent to the iSCSI initiator via a virtual iSCSI target.

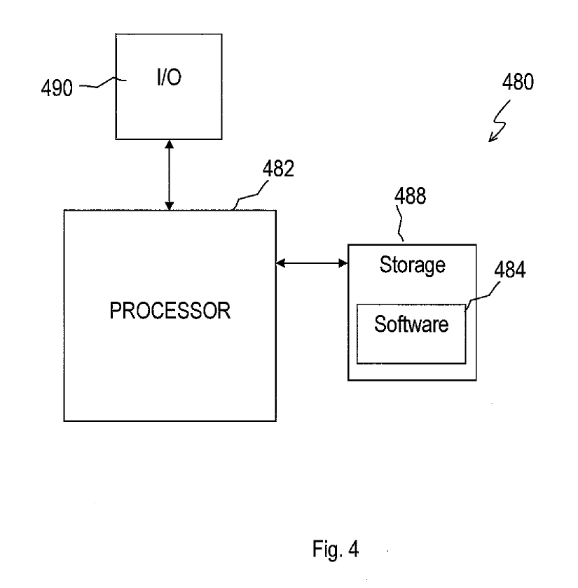

The system described above may be implemented on any general-purpose computer with sufficient processing power, memory resources, and throughput capability to handle the necessary workload placed upon the computer. FIG. 4 illustrates a typical, general-purpose computer system 480 suitable for implementing one or more embodiments disclosed herein. The computer system 480 includes a processor 482 (which may be referred to as a central processor unit or CPU) that is in communication with memory devices including storage 488, and input/output (I/O) 490 devices. The processor may be implemented as one or more CPU chips.

In various embodiments, the storage 488 includes a computer readable medium such as volatile memory (e.g., RAM), non-volatile storage (e.g., Flash memory, hard disk drive, CD ROM, etc.), or combinations thereof. The storage 488 includes software 484 that is executed by the processor 482. One or more of the actions described herein are performed by the processor 482 during execution of the software 484.

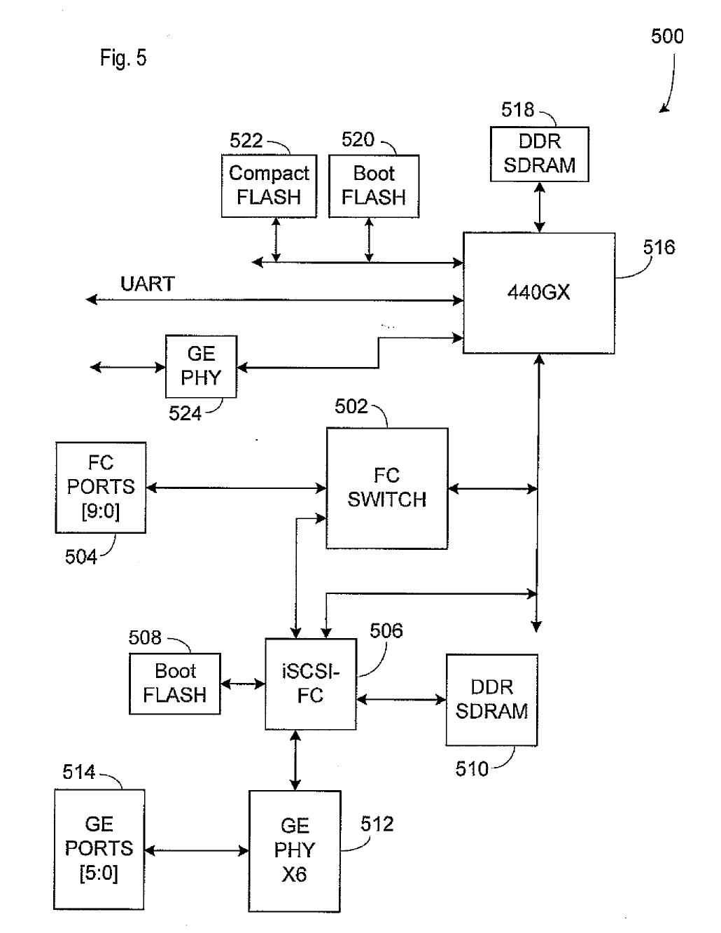

FIG. 5 illustrates the preferred embodiment of the gateway 102. A Fibre Channel switch 502 and an iSCSI to Fibre Channel conversion block 506 are the primary components of the gateway 500. The switch 502 has associated Fibre Channel ports 504. The iSCSI to Fibre Channel conversion block 506 preferably includes network processor or processors such as the BCM 1125 from Broadcom. Boot FLASH 508 is provided to contain the firmware used by the network processor. SDRAM 510 provides both working RAM and temporary packet storage functions for the network processor. An Ethernet PHY 512 and its related Ethernet ports 514 are connected to the iSCSI to Fibre Channel conversion block to form the iSCSI port. The iSCSI to Fibre Channel conversion block 506 is connected to the Fibre Channel switch 502 using a Fibre Channel link.

A processor 516 performs high level operations for the gateway with both the iSCSI and Fibre Channel SANs and performs control functions over the Fibre Channel switch 502 and the iSCSI to Fibre Channel conversion block 506. RAM 518 provides working memory for the processor 516, with FLASH 520 containing the basic firmware code and FLASH 522 providing long term bulk storage. An Ethernet PHY 524 is provided to provide an out of band management connection to the gateway 500, along with a UART connection.

The above disclosure is meant to be illustrative of the principles and various embodiment of the present invention. Numerous variations and modifications will become apparent to those skilled in the art once the above disclosure is fully appreciated. For example, the order of the actions shown in FIGS. 2 and 3 can be varied from the order shown, and two or more of the actions may be performed concurrently. Also, protocols other than FC and iSCSI may be used. It is intended that the following claims be interpreted to embrace all such variations and modifications.

I claim:

1. A gateway, comprising:
a first port configured to couple to a first protocol target, the first protocol target associated with a first protocol; and
a second port configured to couple to a plurality of second protocol initiators, the plurality of second protocol initiators associated with a second protocol, the second protocol not identical to the first protocol,
wherein the second port is configured to facilitate communication between the plurality of second protocol initiators and the first protocol target;
wherein the second port is configured to proxy the plurality of second protocol initiators as a single virtual first protocol initiator;
wherein the second port is configured to divide a communication identifier range associated with the first protocol into a plurality of subdivided communication identifier ranges; and
wherein the second port is configured to associate the plurality of second protocol initiators with the plurality of subdivided communication identifier ranges.

2. The gateway of claim 1, wherein the second port is configured to use a subdivided communication identifier range out of the plurality of subdivided communication identifier ranges to identify communication between the first protocol target and a second protocol initiator out of the plurality of second protocol initiators.

3. The gateway of claim 1, wherein the second port is configured associate the plurality of second protocol initiators with the plurality of subdivided communication identifier ranges in a one-to-one ratio.

4. The gateway of claim 1,
wherein the second port is configured to communicate with the plurality of second protocol initiators via a virtual second protocol target; and
wherein the second port is configured to communicate with the first protocol target via the virtual first protocol initiator.

5. The gateway of claim 1,
wherein the first protocol comprises Fibre Channel protocol; and
wherein the second protocol comprises iSCSI protocol.

6. The gateway of claim 5, wherein the communication identifier range is an Origination Exchange Identifier (“OX_ID”) range associated with the Fibre Channel protocol.

7. The gateway of claim 6, wherein the second port is configured to divide the OX_ID range into 64 subdivided communication identifier ranges.

8. The gateway of claim 5, wherein the second port is configured to convert iSCSI packets into Fibre Channel frames and to convert Fibre Channel frames into iSCSI packets.

9. The gateway of claim 5,
wherein the first port comprises a Fibre Channel port; and
wherein the second port comprises an iSCSI port.

10. The gateway of claim 9,
wherein the plurality of second protocol initiators comprises 64 iSCSI initiators; and
wherein the first protocol target comprises a Fibre Channel storage units.

11. The gateway of claim 10, further comprising:
a plurality Fibre Channel ports configured as the first port is configured; and
a plurality of iSCSI ports configured as the second port is configured.

12. A method, comprising:
receiving a packet at a virtual second protocol target from a second protocol initiator, the second protocol initiator associated with a second protocol;
inserting a communication identifier associated with the second protocol initiator into the packet; and
sending the packet from a virtual first protocol initiator to a first protocol target, the first protocol target associated with a first protocol, the first protocol different from the second protocol.

13. The method of claim 12, wherein inserting the communication identifier further comprises determining the communication identifier associated with second protocol initiator.

14. The method of claim 13, wherein determining the communication identifier comprises:
determining a subdivided communication identifier range associated with the second protocol initiator out of a plurality of subdivided communication identifier ranges, a plurality of second protocol initiators comprising the second protocol initiator, the plurality of second protocol initiators associated with the plurality of subdivided communication identifier ranges in a one-to-one ratio; and
determining the communication identifier associated with the subdivided communication identifier range.

15. The method of claim 12, further comprising converting the packet into a first protocol packet.

16. The method of claim 12, wherein the first protocol is Fibre Channel protocol and the second protocol is iSCSI protocol.

17. The method of claim 16, wherein inserting the communication identifier comprises inserting an Origination Exchange Identifier associated with the second protocol initiator into the packet.

18. A computer-readable medium storing a software program that, when executed by a processor, causes the processor to:
receive a packet at a virtual second protocol target from a second protocol initiator, the second protocol initiator associated with a second protocol;
insert a communication identifier associated with the second protocol initiator into the packet; and
send the packet from a virtual first protocol initiator to a first protocol target, the first protocol target associated with a first protocol, the first protocol different from the second protocol.

19. The computer-readable medium of claim 18, further causing the processor to direct subsequent packets between the second protocol initiator and the first protocol target based on the communication identifier.

20. The method of claim 18, wherein inserting the communication identifier further causes the processor to determine the communication identifier associated with second protocol initiator.

21. The computer-readable medium of claim 20, wherein determining the communication identifier causes the processor to:
determine a subdivided communication identifier range associated with the second protocol initiator out of a plurality of subdivided communication identifier ranges, a plurality of second protocol initiators comprising the second protocol initiator, the plurality of second protocol initiators associated with the plurality of subdivided communication identifier ranges in a one-to-one ratio; and
determine the communication identifier associated with the subdivided communication identifier range.

22. The computer-readable medium of claim 18, further causing the processor to convert the packet into a first protocol packet.

23. The computer-readable medium of claim 18, wherein the first protocol is Fibre Channel protocol and the second protocol is iSCSI protocol.

24. The computer-readable medium of claim 23, wherein inserting the communication identifier causes the processor to insert an Origination Exchange Identifier associated with the second protocol initiator into the packet.

25. A method, comprising:
receiving a Fibre Channel frame at a virtual Fibre Channel initiator from a Fibre Channel target;
reading the Origination Exchange Identifier located in the Fibre Channel frame;
identifying an iSCSI initiator out of a plurality of iSCSI initiators via the Origination Exchange Identifier;
converting the Fibre Channel frame to an iSCSI packet; and
sending the iSCSI packet from a virtual iSCSI target to the iSCSI initiator.
